(19) United States
(12) Patent Application Publication
(10) Pub. No.: US 2006/0032833 A1
(43) Pub. Date: Feb. 16, 2006

(54) Encapsulation of post-etch halogenic residue

(75) Inventors: Mark Naoshi Kawaguchi, Mountain View, CA (US); Thorsten B. Lill, Santa Clara, CA (US); Anisul H. Khan, Santa Clara, CA (US)

Correspondence Address: MOSER, PATTERSON & SHERIDAN, LLP;APPLIED MATERIALS INC, 595 SHREWSBURY AVE, SUITE 100, SHREWSBURY, NJ, 07702, US

(73) Assignee: Applied Materials, Inc.

(21) Appl. No.: 10/915,519

(22) Filed: Aug. 10, 2004

(51) Int. Cl. B44C 1/22

(52) U.S. Cl. 216/37

(57) ABSTRACT

A method of etching is provided that includes transferring a substrate into a vacuum environment, etching a material layer on the substrate and depositing a polymeric film encapsulating etch residues on the substrate without removing the substrate from the vacuum environment.

### BACKGROUND OF THE INVENTION

1. Field of the Invention

The present invention generally relates to a method for fabricating devices on semiconductor substrates. More specifically, the present invention relates to a method for encapsulating halogenic residue after plasma etch processing a substrate.

2. Description of the Related Art

Integrated circuits (ICs) include micro-electronic devices (e.g., transistors, capacitors, and the like) that are formed on a semiconductor substrate and cooperate to perform various functions within the IC. Additionally, various micro-electromechanic systems (MEMS), such as actuators, sensors, and the like, may also be fabricated on the same substrate and integrated with the ICs.

Fabrication of the electronic devices and MEMS comprises performing plasma etch processes in which one or more layers of a film stack of the device of MEMS are plasma etched and removed, partially or in total. The plasma etch processes may use chemically aggressive etchants comprising halogen-containing gases (e.g., nitrogen trifluoride (NF₃), carbon tetrafluoride (CF₄), chlorine (Cl₂), hydrogen bromide (HBr), and the like). Such etch processes develop halogen-containing residue that forms on the surfaces of the etched features, etch masks, and elsewhere on the substrate. Conventionally, plasma etch processes, as well as intermittent metrology operations, are performed using different substrate processing systems and metrology tools. Cassettes with the etched substrates are generally transferred between the substrate processing systems and metrology tools using factory interfaces, which generally are atmospheric pressure transports used to couple processing systems within a semiconductor fab.

When exposed to a non-vacuumed environment, halogen-containing residues release gaseous halogens and halogen-based reactants (e.g., bromine (Br₂), chlorine, hydrogen chloride (HCl), and the like). These reactants may cause corrosion and/or particle contamination of interior of the processing systems and metrology tools that are coupled to the factory interface and of the interface itself, as well as promote substrate defects by corrosion of metallic layers on the substrate and/or cross contamination of unetched substrates from outgassing (etched) substrates that adversely affects future processing of the substrate, for example, by blocking or preventing etching of contaminated regions. Replacement of the corroded parts and cleaning factory interfaces are time consuming and expensive procedures, which considerably increase costs of micro-electronic devices. Additionally, reduction of substrate defects is highly desirable. Thus, it would be desirable to prevent the release of halogens from etch residues on substrates.

Therefore, there is a need in the art for an improved method for encapsulation of halogenic post-etch residue in manufacture of integrated circuits.

### SUMMARY OF THE INVENTION

A method for encapsulating post-etch halogenic residue on a material layer of a substrate is provided. In one embodiment, the method comprises etching a material layer using a halogen containing gas in an etch reactor and depositing a polymeric film that encapsulates the etch residue on the substrate without removing the substrate from a vacuum environment.

### BRIEF DESCRIPTION OF THE DRAWINGS

The teachings of the present invention can be readily understood by considering the following detailed description in conjunction with the accompanying drawings, in which:

FIG. 1 depicts a flow diagram of a method for encapsulating halogen-containing residue in accordance with one embodiment of the present invention;

FIG. 2A-2F, together, depict a series of schematic, cross-sectional views of a substrate where a trench is formed in accordance with the method of FIG. 1;

FIG. 3 depicts a schematic diagram of an exemplary plasma processing apparatus of the kind used in performing portions of the method of the present invention; and

FIG. 4 depicts a schematic diagram of a portion of a manufacturing region of a semiconductor fab that may be used to perform the method of the present invention.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention is a method for encapsulating residue formed after etching a material layer on a substrate (e.g., semiconductor substrate) in a plasma etch reactor. The method may be used in manufacture of integrated circuits (ICs) and micro-electromechanic systems (MEMS).

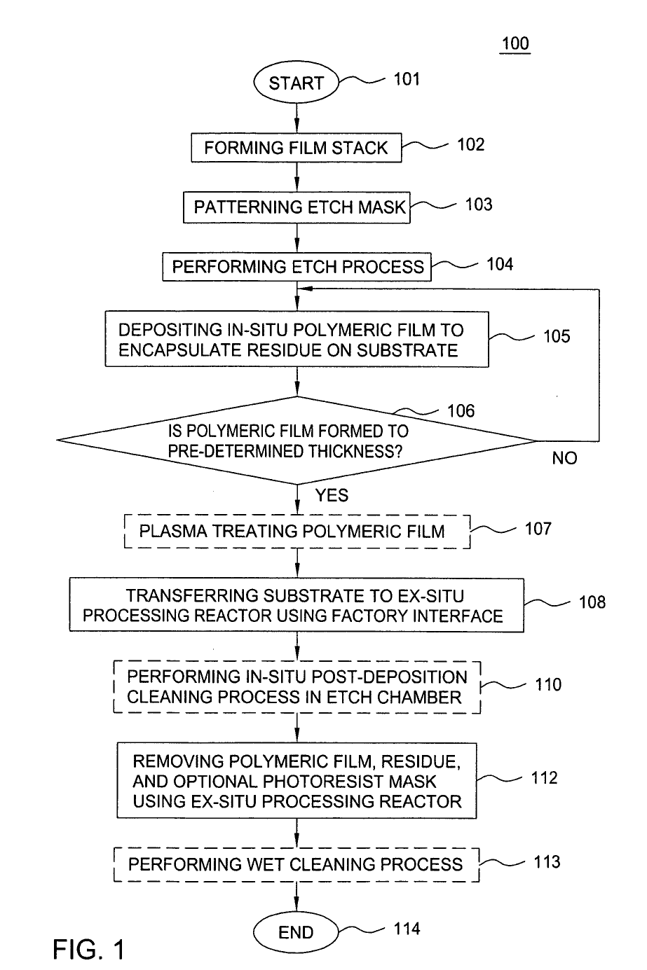

FIG. 1 depicts a flow diagram for one embodiment of the inventive method for encapsulating residue as a process 100. The process 100 includes the processes that are performed upon a substrate during fabrication of a trench of a trench capacitor.

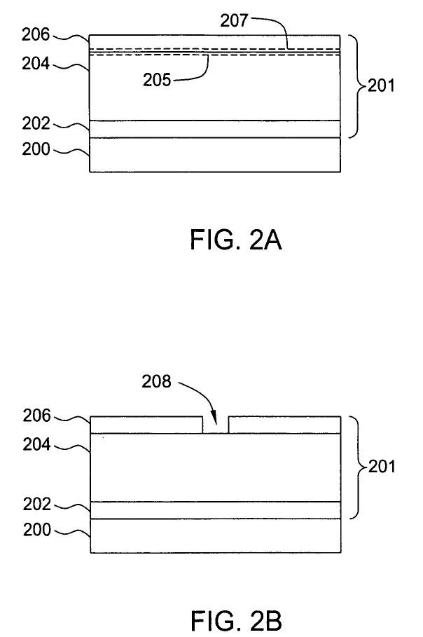

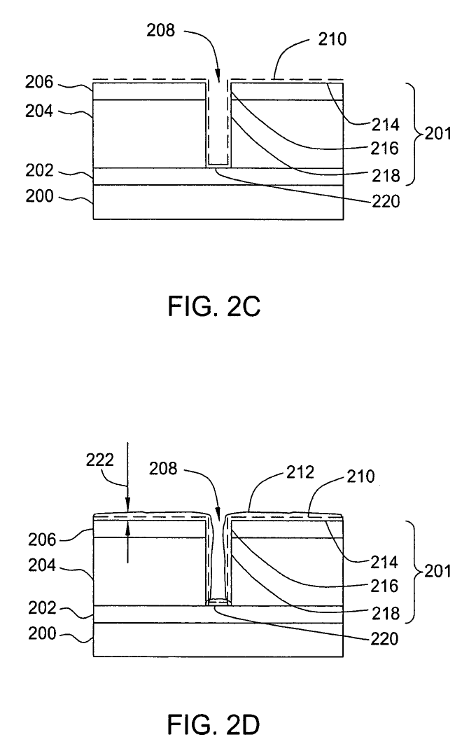

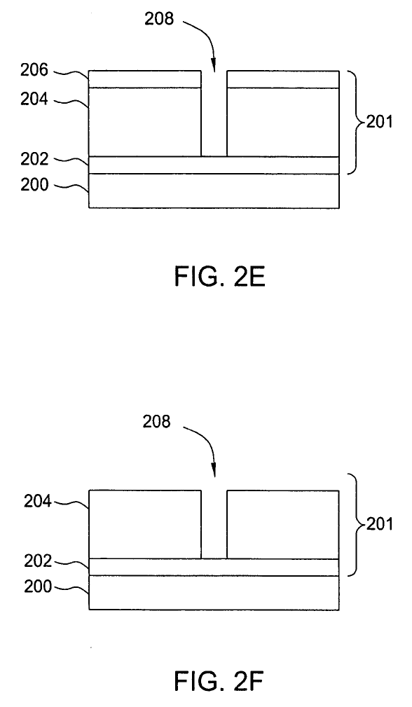

FIGS. 2A-2F depict a series of schematic, cross-sectional views of a substrate where an exemplary trench of the trench capacitor is formed using the process 100. The cross-sectional views in FIGS. 2A-2F relate to individual processing steps that are used to fabricate the trench. The images in FIGS. 2A-2F are not depicted to scale and are simplified for illustrative purposes. To best understand the invention, the reader should simultaneously refer to FIG. 1 and FIGS. 2A-2F.

The process 100 starts at step 101 and proceeds to step 102, where a film stack 201 is formed on a substrate 200, such as a silicon (Si) wafer, and the like (FIG. 2A). The film stack 201 illustratively comprises a mask layer 206, a material layer 204, and an optional barrier layer 202 (e.g., oxide (SiO₂), oxynitride (SiON) or C-doped oxide (SiₓO_{y}C_{z})). In one exemplary embodiment, the material layer 204 is formed from silicon (Si) and the mask layer 206 is formed from borosilicate glass (BSG). The silicon layer 204 may comprise an optional top film 205 of silicon dioxide (SiO₂), as well as the BSG mask layer 206 may comprise an optional anti-reflective coating (ARC) 207 (e.g., silicon nitride (Si₃N₄), oxynitride (SiON) and the like). The ARC is conventionally used to control the reflection of light used to pattern the mask layer 206 (discussed below in reference step 103). For a purpose of graphical clarity, the film 205 and ARC 207 are shown, with broken lines, in FIG. 2A only. It is contemplated that amorphous carbon can be used as both the ARC layer 207 and hard mask layer 206. The mask layer 206 may be disposed above or below the ARC layer 207.

In alternate embodiments, the material layer 204 may comprise at least one of polysilicon (Si), a dielectric material (e.g., silicon dioxide, hafnium silicate (HfSiO₄), hafnium dioxide (HfO₂), and the like), and a conductive material (e.g., metal, metal alloy, and the like including Ti, TiN, TaN, TaSiN, W and WSiₓ, among others), as well as the mask layer 206 may be formed from photoresist. The photoresist mask layer 206 may also comprise the ARC. In this scheme, the photoresist may be used as a mask for the deep trench etch instead of being used solely to pattern a hard mask.

The layers comprising the film stack 201 may be formed using any conventional vacuum deposition technique, such as atomic layer deposition (ALD), physical vapor deposition (PVD), chemical vapor deposition (CVD), plasma enhanced CVD (PECVD), and the like. Fabrication of the film stack 201 may be performed using, e.g., the respective processing modules of CENTURA®, ENDURA®, and other semiconductor wafer processing systems available from Applied Materials, Inc. of Santa Clara, Calif.

At step 103, the mask layer 206 is lithographically patterned with an image of a trench 208 to be formed in the material layer 204 (FIG. 2B). A patterning process may use a sacrificial photoresist mask (not shown) that is stripped after the mask layer 206 has been patterned. In one embodiment (not shown) when the mask layer 206 comprises the ARC 207, the image of the trench 208 may be transferred only in an upper portion (e.g., BSG portion) of the mask layer 206. The sacrificial photoresist mask may also comprise the ARC or be optionally trimmed to smaller topographic dimensions using, for example, a plasma trimming process. When formed from the photoresist, the mask layer 206 may be patterned using the same processes as described above in reference to the sacrificial photoresist mask.

Processes that may be used for patterning the mask layer 206 are described, for example, in commonly assigned U.S. patent application Ser. No. 10/218,244, filed Aug. 12, 2002 (Attorney Docket Number 7454) and Ser. No. 10/245,130, filed Sep. 16, 2002 (Attorney Docket Number 7524), which are incorporated herein by reference.

At step 104, the trench 208 is formed in the material layer 204 (FIG. 2C). Illustratively, the trench 208 may have a width of about 0.1 to 0.15 μm and a depth of about 7 to 11 μm, which corresponds to an aspect ratio in a range from about 20 to 100. Herein, the term “aspect ratio” refers to a height of the trench divided by its width. In one embodiment, the trench 208 is formed in the silicon layer 204 using a plasma etch process that includes at least one halogen gas such as carbon tetrafluoride (CF₄), hydrogen bromide (HBr), nitrogen trifluoride (NF₃), chlorine (Cl₂), and the like.

In another embodiment, the trench 208 is formed in the silicon layer 204 using a plasma etch process that includes between about 100 to about 1000 sccm HBr, about 10 to about 300 sccm NF₃, about 5 to about 200 sccm O₂, exciting a plasma formed from the gas mixture with about 500 to about 3000 W, biasing the cathode with about 500 to about 3000 W, maintaining the process chamber at a pressure between about 50 to about 500 mTorr, and maintaining the substrate between about 20 to about 250 degrees Celsius for a duration of about 180 to about 1800 seconds. In another specific embodiment, the etch process includes providing about 300 sccm HBr, 50 sccm NF₃, about 20 sccms O₂, about 150 W plasma power, about 150 W of bias power, maintaining the chamber pressure at about 150 mTorr, and maintaining the substrate at about 150° C. for a duration of about 900 seconds.

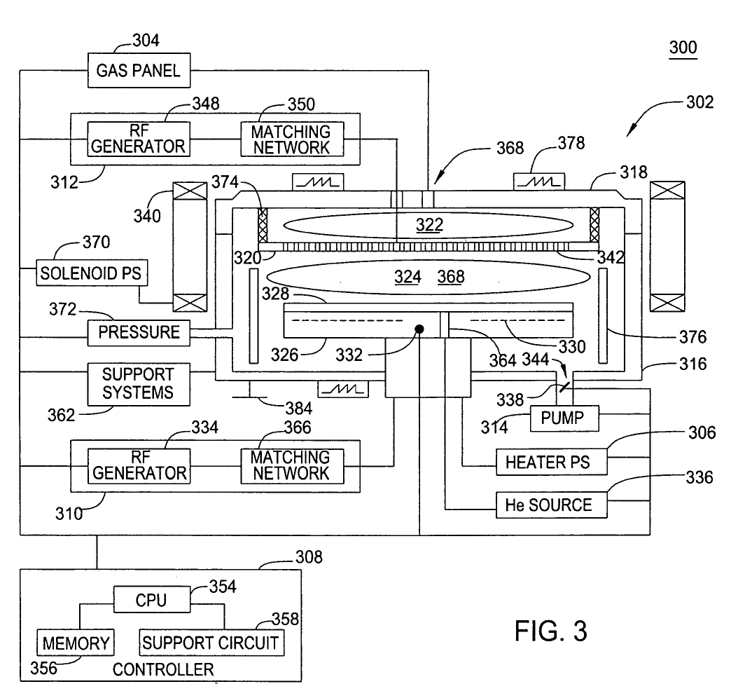

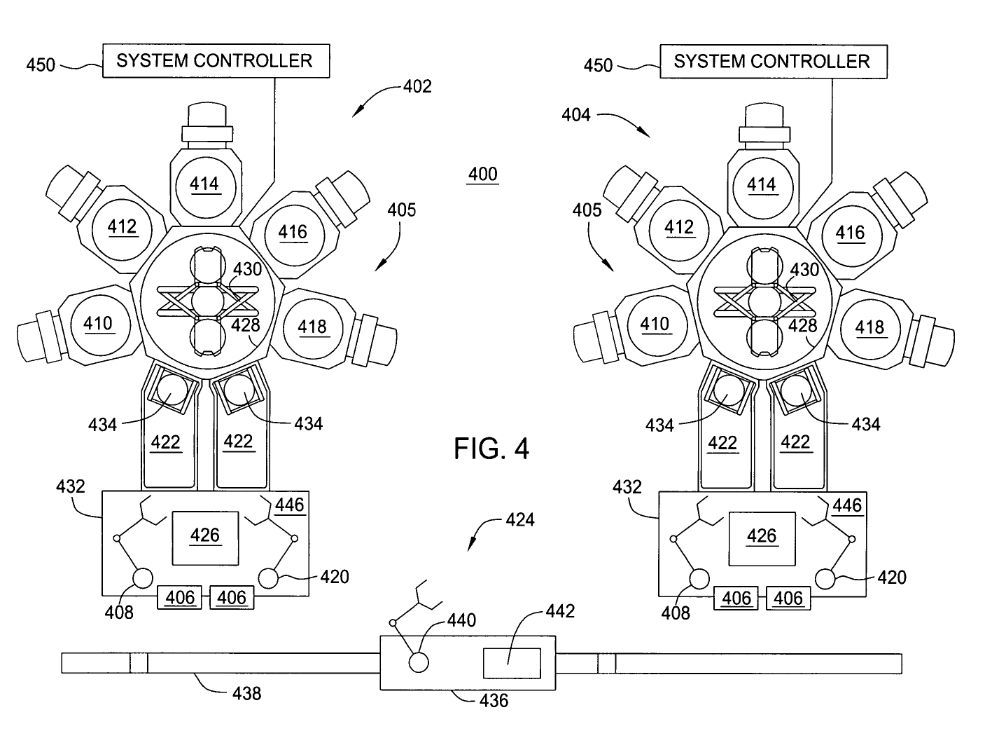

Such etch process may be performed using, e.g., a high aspect ratio (HART) module of the CENTURA® system (discussed below in reference to FIGS. 3 and 4). Alternatively, the plasma etch process may be performed using other etch reactors, e.g., a DPS® II module of the CENTURA® system. The HART® and DPS® II modules are available from Applied Materials, Inc. of Santa Clara, Calif. It is contemplated that other etch reactors, including those available from other manufacturers, may be alternatively utilized.

The plasma etch process may produce halogenic (i.e., halogen-containing) residue 210 (shown with broken lines) that forms on sidewalls 218 and a bottom 220 of the trench 208, as well as on sidewalls 216 and a top surface 214 of the mask layer 206. When the substrate 200 is exposed to non-vacuumed environment (e.g., factory interface), the halogenic residue 210 outgasses halogens and halogen-based reactants, such as bromine (Br₂), chlorine (Cl₂), hydrogen chloride (HCl), hydrogen bromide (HBr), and the like. The outgassed halogens and halogen-based reactants may cause corrosion of the factory interfaces, particle contamination in the manufacturing areas of the semiconductor fab, corrosion of metallic layers on the substrates and cross contamination of etched to unetched substrates. As such, outgassing from the residue 210 should be prevented until the substrate 200 is subjected to a residue removal process.

At step 105, a polymeric film 212 is deposited on the substrate 200 (FIG. 2D). In one embodiment, the polymeric film 212 covers the entire topography (i.e., device side) of the substrate 200. Specifically, the polymeric film 212 is formed on the top surface 214 and sidewalls 216 of the mask 206, the sidewalls 218 and bottom 220 of the trench 208, and elsewhere on a device surface of the substrate 200, thereby encapsulating the residue 210.

Step 105 is performed prior to exposing the substrate to a non-vacuum environment. Thus, the step 105 may be performed within the etch chamber or within another chamber coupled to the etch chamber by a route maintained under vacuum, such as another chamber coupled with the etch chamber to a common transfer chamber (e.g., a cluster tool).

In one embodiment, the polymeric film 212 is in-situ formed in the etch reactor using at least one of a fluorocarbon gas and hydrocarbon gas, as well as at least one optional gas such as oxygen (O₂), carbon dioxide (CO₂), water vapor (H₂O), hydrogen (H₂), nitrogen (N₂), ammonia (NH₃), bromine (Br₂), chlorine (Cl₂), fluorine (F₂), hydrogen bromide (HBr), hydrogen chloride (HCl), hydrogen fluoride (HF), nitrogen trifluoride (NF₃), a forming gas, and the like. Herein, the terms “gas” and “gas mixture” are used interchangeably. In this embodiment, the fluorocarbon gas may comprise at least one of carbon tetrafluoride (CF₄), difluoromethane (CH₂F₂), trifluoromethane (CHF₃), CH₃F, C₂F₆, C₂F₄, C₃F₈, C₄F₆, C₄F₈, and the like, and the hydrocarbon gas may comprise at least one gas having a chemical formula CₓH_{y}, where x and y are integers. The forming gas typically comprises a mixture of about 3-5% of hydrogen and 95-97% of nitrogen. To develop the polymeric film 212, step 105 energizes the gas mixture to form a plasma in a processing chamber of the etch reactor (e.g., the HART® or DPS® II modules of the CENTURA® system).

The polymeric film 212 is deposited to a pre-selected thickness 222 that is sufficient to encapsulate the residue 210 on the substrate 200 during a pre-determined time interval (e.g., about 30 seconds to about 2 minutes). The film 212 having the thickness 222 may be easily removed from the substrate using a stripping process (discussed below in reference to step 112). In one embodiment, the thickness 222 is selected such that, during the pre-determined time interval, outgassing from the residue 210 is below a level that may cause corrosion of metals (e.g., below or about the detection levels for the respective halogen-containing gases), as well sufficient to prevent penetration of atmospheric moisture (i.e., water vapor) through the polymeric film 212. Such polymeric film 212 may protect the factory interfaces from corrosion and particle contamination, as well as protect from corrosion the metallic layers on the substrate 200 and/or cross contamination between etched and unetched substrates.

In one embodiment, cross-linking density of the polymeric film 212 is controlled to produce the polymeric film having a surface hardness sufficient to prevent damaging the film and particle generation during transporting the substrate 200 by the substrate robots used in semiconductor processing systems and factory interfaces. To increase the surface hardness, during at least a portion of step 105 the polymeric film 212 may be deposited at elevated substrate bias power. In a further embodiment, the cross-linking density may selectively be controlled to reduce outgassing of the halogen-containing gases and moisture penetration through the polymeric film 212. Specifically, the outgassing and moisture penetration decrease when the cross-linking density of the polymeric film 212 increases. Moisture penetration is also controlled by process chemistry, such as gas mixtures that promote hydrophobic surfaces (CₓH_{y} or CₓH_{y}F_{z}).

In another embodiment, during deposition of the polymeric film 212, adhesion of by-products of the deposition process to surfaces of the components of the processing chamber is selectively controlled to minimize particle contamination of the chamber. In one embodiment, the adhesion of the by-products is controlled using pre-defined gas mixtures and processing parameters.

In one exemplary embodiment, the polymeric film 212 is in-situ deposited using the HART® module by providing carbon tetrafluoride (CF₄) at a flow rate of about 10 to 200 sccm, hydrogen (H₂) at a flow rate of about 0 to 600 sccm (i.e., a CF₄:H₂ flow ratio ranging from 0:1 to 5:1), applying a plasma source power between about 500 and 2500 W, applying a cathode bias power between about 500 and 2500 W, a magnetic field of about 0 to 90 Gauss, and maintaining a wafer pedestal temperature of about 20 to 90 degrees Celsius and a chamber pressure between about 30 and 500 mTorr. In an alternative embodiment, carbon tetrafluoride may be replaced with trifluoromethane (CHF₃) or a mixture thereof. One illustrative process uses CF₄ at a flow rate of 70 sccm, H₂ at a flow rate of 40 sccm (i.e., a CF₄:H₂ flow ratio of about 1.75:1), applies 2400 W of plasma source power, 0 W of cathode bias power, a magnetic field of 90 Gauss, and maintains a wafer pedestal temperature of about 65 degrees Celsius and a chamber pressure of 250 mTorr. In one embodiment, the polymeric film 212 is deposited to the thickness 222 of about 500 to 5000 Angstroms to provide protection from outgassing of the halogen-containing gases and moisture penetration for about 4-12 hours.

At step 106, the process 100 queries if the polymeric film 212 has been formed to the pre-determined thickness 222. If the query of step 106 is negatively answered, the process 100 proceeds to step 105 to continue depositing the film. If the query of step 106 is affirmatively answered, the process 100 proceeds to step 108.

At an optional step 107, the polymeric film 212 may be additionally plasma treated to increase the cross-linking density of the film. In one embodiment, step 107 in-situ exposes the polymeric film 212 to a plasma of at least one inert gas, such as argon (Ar), neon (Ne), and the like. In one exemplary embodiment, the polymeric film 212 is in-situ plasma treated using the HART® module by providing argon (Ar) at a flow rate of about 10 to 200 sccm, applying a plasma source power between about 1000 and 3000 W, applying a cathode bias power between about 0 and 3000 W, a magnetic field of about 0 to 90 Gauss, and maintaining a wafer pedestal temperature of about 20 to 90 degrees Celsius and a chamber pressure between about 30 and 300 mTorr. Such a plasma treatment may have a duration of about 10 to 60 sec. One illustrative process uses Ar at a flow rate of 100 sccm, applies 2400 W of plasma source power, 2400 W of cathode bias power, a magnetic field of about 0 Gauss, and maintains a wafer pedestal temperature of 30 degrees Celsius and a chamber pressure of 250 mTorr.

At step 108, the substrate 200 is removed from the etch reactor (e.g., HART® module) and transferred to another processing region of the semiconductor fab using a factory interface. The factory interface is generally an atmospheric pressure apparatus that is used to transfer cassettes with the substrates between manufacturing systems and regions of the semiconductor fab. In one embodiment, the factory interface illustratively comprises a cassette handling device and a track (discussed below in reference to FIG. 4). In operation, the cassette handling device moves along the track. In one embodiment, the factory interface transfers a cassette with the substrates 200 to a strip reactor that is external (i.e., ex-situ reactor) to the etch reactor described in reference to steps 102-106. The ex-situ strip reactor may be a stand-alone apparatus or, as depicted in FIG. 4, a portion of an integrated semiconductor substrate processing system, such as the CENTURA® system.

At step 110, the etch reactor (e.g., HART® module) performs a cleaning process. The cleaning process is performed after the substrate 200 is removed from the processing chamber of the reactor. Such a process removes traces of by-products of the etch and deposition processes of steps 104, 105 from interior of the processing chamber of the reactor. In some applications, the cleaning process is not needed or may be performed after processing a batch of the substrates 200. As such, step 110 is considered optional. In one exemplary embodiment, step 110 uses a cleaning gas comprising at least one of oxygen (O₂), nitrogen trifluoride (NF₃), and hydrogen (H₂). During the cleaning process, such a gas is energized to form a plasma that transforms the by-products into volatile compounds that are further pumped away from the processing chamber using an exhaust system of the etch reactor. Other cleaning gases may include at least one of O₂, CF₄, Cl₂, N₂, Ar, He and the like.

In one exemplary embodiment, the processing chamber of the HART® module is cleaned by providing oxygen (O₂) at a flow rate of about 50 to 1000 sccm, NF₃ at a flow rate of about 0 to 200 sccm (i.e., an NF₃:O₂ flow ratio ranging from 0:1 to 0.8:1), applying a plasma source power between about 500 and 3000 W, applying a cathode bias power between about 0 and 3000 W, a magnetic field of about 0 to 90 Gauss, and maintaining a wafer pedestal temperature of about 20 to 90 degrees Celsius and a chamber pressure between about 50 and 500 mTorr. In one optional embodiment, during the cleaning process, the flow rates of oxygen and ammonia are selectively adjusted. One illustrative process applies 2400 W of plasma source power, 0 W of cathode bias power, a magnetic field of about 0 Gauss, maintains a wafer pedestal temperature of 30 degrees Celsius and a chamber pressure of about 100 mTorr, and uses O₂ at a flow rate of 1000 sccm for about 30 sec and NF₃ at a flow rate of 1000 sccm for about 60 sec.

At step 112, the ex-situ strip reactor strips the polymeric film 212 and removes the residue 210 from the substrate 200 (FIG. 2E). In the embodiment when the mask layer 206 is formed from photoresist, step 112 contemporaneously strips such a mask layer (FIG. 2F). Step 112 may be accomplished performing either a plasma strip process or a wet strip process. In some applications, step 112 performs an additional wet strip process after the plasma strip process.

In one embodiment, step 112 performs the plasma strip process using a source gas comprising at least one of oxygen (O₂), water vapor (H₂O), and ozone (O₃), and, optionally, nitrogen (N₂). In one exemplary embodiment, the polymeric film 212, residue 210, and photoresist mask 206 are removed using, e.g., an Advanced Strip and Passivation (ASP) module or an AXIOM™ module of the CENTURA® system.

The ASP and AXIOM™ modules are, respectively, a microwave downstream plasma reactor and a remote plasma radio-frequency (RF) reactor. In these reactors, a plasma is confined such that only reactive neutrals are allowed to enter the processing chamber, thus precluding plasma-related damage to the circuits being formed on the substrate. The ASP and AXIOM™ reactors are described, e.g., U.S. patent application Ser. No. 10/446,332, filed May 27, 2003 (Attorney docket number 8171) and Ser. No. 10/264,664, filed Oct. 4, 2002 (Attorney docket number 6094), respectively, which are herein incorporated by reference.

In one exemplary embodiment, using the AXIOM™ module, step 112 provides oxygen (O₂) at a flow rate of about 1000 to 10000 sccm, nitrogen (N₂) at a flow rate of about 50 to 1000 sccm (corresponds to an O₂:N₂ flow ratio ranging from about 5:1 to 50:1), applies 1000 to 6000 W at about 200 to 600 kHz to form the remote RF plasma, and maintains a wafer pedestal temperature of about 175 to 350 degrees Celsius and a chamber pressure between 0.5 and 2.0 Torr. Such a process generally has a duration of about 10 to 100 sec. Alternatively, such a process may be performed using the ASP® II module.

One illustrative process, when performed using the AXIOM™ module, provides about 6000 sccm of O₂, about 600 sccm of N₂ (i.e., an O₂:N₂ flow ratio of about 10:1), about 5000 W of plasma source power, maintains a wafer pedestal temperature of about 200 degrees Celsius and a chamber pressure of about 1.25 Torr, and has a duration of about 60 sec. When performed using the ASP® II module, the process provides about 3500 sccm of O₂, 250 sccm of N₂ (i.e., an O₂:N₂ flow ratio of about 14:1), about 1400 W of plasma source power, maintains a wafer pedestal temperature of about 250 degrees Celsius and a chamber pressure of about 2.0 Torr, and has a duration of about 60 sec.

In an alternate embodiment, step 112 performs a wet strip process using a solvent comprising at least one of sulfuric acid (H₂SO₄) and hydrogen peroxide (H₂O₂). In one exemplary embodiment, the polymeric film 212, residue 210, and, when present, photoresist mask 206 are removed using the solvent comprising, by volume, about 70% of sulfuric acid and 30% of sulfuric acid. Such a process is typically performed at a solvent temperature of about 120 degrees Celsius. After exposure to the solvent, the substrate 200 is conventionally rinsed using deionized (DI) water.

At an optional step 113, the substrate 200 undergoes a wet cleaning process. In one embodiment, step 113 performs a bath dip of the substrates 200 in a solution that comprises hydrogen fluoride (HF) and deionized water. In one exemplary embodiment, the solution comprises, by volume, between 0.5 and 2% of hydrogen fluoride. In a further embodiment, the solution may additionally comprise at least one of nitric acid (HNO₃) and hydrogen chloride (HCl). To shorten the process time, step 113 be performed using an ultrasonic bath. Upon completion of the wet dip, the substrate 200 is rinsed in DI water to remove any traces of the solution.

At step 114, the process 100 ends.

FIG. 3 depicts a schematic diagram of the HART® reactor 300 that illustratively may be used to practice the inventive method. The images in FIG. 3 are simplified for illustrative purposes and are not depicted to scale. Other etch reactors may also be used to practice the invention, such as the DPS® II reactor disclosed, e.g., in commonly assigned U.S. patent application Ser. No. 10/463,460, filed Jun. 16, 2003 (Attorney docket number 7586), which is incorporated herein by reference.

In one embodiment, the reactor 300 comprises a processing chamber 302, a gas panel 304, a source 336 of a backside gas, a heater power supply 306, a vacuum pump 314, sources 310 and 312 of radio-frequency (RF) power, at least one magnetizing solenoid 340, support systems 362, and a controller 308.

The processing chamber 302 is generally a vacuum vessel that comprises a substrate pedestal 326, a gas distribution plate (showerhead) 320, a protective liner 376, a lid 318, and a conductive wall 316. The showerhead 320 separates a gas mixing volume 322 and a reaction volume 324 of the processing chamber 302. In one embodiment, the lid 318 and wall 316 include controlled heating elements 378, as well as conduits (not shown) for heating or cooling liquid or gas. The conductive wall 316 and ground references (not shown) of the sources 310 and 312 are electrically coupled to a ground terminal 384 of the reactor 300.

In operation, the substrate pedestal 326 supports a substrate 328 (e.g., silicon (Si) wafer). In the depicted embodiment, the substrate pedestal 326 includes an embedded resistive heater 330 to heat the substrate pedestal. In other embodiments, the substrate pedestal 326 may comprise a source of radiant heat (not shown), such as gas-filled lamps and the like. A temperature sensor 332 (e.g., thermocouple) monitors, in a conventional manner, the temperature of the substrate pedestal 326. The measured temperature is used in a feedback loop to regulate the output of the heater power supply 306 that controls the heater 330 or, alternatively, to the gas-filled lamps.

The support pedestal 326 further includes a gas supply conduit 364 that provides the backside gas, e.g., helium (He), from the source 336 to the backside of the wafer 328 through the grooves (not shown) in a support surface of the support pedestal. The backside gas facilitates heat exchange between the support pedestal and the wafer 328. Using the backside gas, the temperature of the wafer 328 may be controlled between about 20 and 350 degrees Celsius.

The gas panel 304 comprises sources of process and cleaning gases, as well as equipment for delivery and regulating the flow of each gas. In one embodiment, a process gas (or gas mixture) or a cleaning gas are delivered from the gas panel 304 into the processing chamber 302 through an inlet port 368 in the lid 318. The inlet port 368 is fluidly connected to the gas mixing volume 322 wherein the gases may diffuse radially across the showerhead 320. Alternatively, the process and cleaning gases may by delivered into the processing chamber 302 through separate inlet ports (not shown) in the lid 318 or wall 316. The showerhead 320 fluidly connects the gas mixing volume 322 to the reaction volume 324 via a plurality of apertures 342. The showerhead 320 may comprise different zones such that various gases can be released into the reaction volume 324 at various flow rates.

The vacuum pump 314 is coupled to an exhaust port 344 that is formed in the sidewall 316. The vacuum pump 314 is used to maintain a desired gas pressure in the processing chamber 302, as well as evacuate post-processing gases and volatile compounds from the chamber. In one embodiment, a throttle valve 338 is disposed between the exhaust port 344 and the pump 314 to control the gas pressure in the processing chamber 302. The gas pressure in the processing chamber 302 is monitored by a pressure sensor 372. The measured value is used in a feedback loop to control the gas pressure during processing the wafer 328 or during a chamber cleaning process.

The RF source 310 is coupled to the substrate pedestal 326 and comprises a RF generator 334 and a matching network 366. In one embodiment, the RF generator 334 produces up to 3000 W and may selectively be tuned in a range from about 400 kHz to 13.6 MHz (e.g., at 2 MHz). In other embodiments, the RF generator 334 may produce up to 6000 W at a tuned frequency in a range from about 60 to 100 MHz.

The RF source 312 is coupled to the showerhead 320 that is electrically isolated from the lid 318 by an isolator 374 (e.g., ceramic, polyimide, and the like). In operation, the RF source 312 energizes a gas in the reaction volume 324 to form a plasma 368. The RF source 312 comprises a RF generator 348 and a matching network 350. In one embodiment, the generator 334 produces up to 6000 W and may selectively be tuned in a range from about 60 to 100 MHz.

In one embodiment, the processing chamber 302 includes four magnetizing solenoids 340 that are energized using a controlled power supply 370 (e.g., DC power supply). The solenoids 340 are disposed around perimeter of the processing chamber 302 and, in operation, are utilized to control the lateral position of the plasma 368.

The processing chamber 302 also comprises conventional systems for retaining and releasing the wafer 328, detection of an end of a performed process, internal diagnostics, and the like. Such systems are collectively depicted in FIG. 3 as support systems 362.

The controller 308 generally comprises a central processing unit (CPU) 354, a memory 356, and support circuits 358. The CPU 354 may be of any form of a general purpose computer processor that can be used in an industrial setting. The software routines can be stored in the memory 356, such as random access memory, read only memory, floppy or hard disk drive, or other form of digital storage. The support circuits 358 are conventionally coupled to the CPU 354 and may comprise cache, input/output sub-systems, clock circuits, power supplies, and the like. The software routines, when executed by the CPU 354, transform the CPU into a specific purpose computer (controller) 308 that controls the reactor 300 such that the processes are performed in accordance with the present invention. In an alternate embodiment, the software routines may also be stored and/or executed by a second controller (not shown) that is located remotely from the reactor 300.

FIG. 4 depicts a schematic diagram of a portion of a manufacturing region 400 of a semiconductor fab. The manufacturing region 400 may illustratively be used to perform the inventive method. In one embodiment, the manufacturing region 400 includes integrated semiconductor substrate processing systems 402 and 404. In the depicted embodiment, the integrated semiconductor substrate processing systems 402 and 404 are illustratively the TRANSFORMA™ semiconductor wafer processing systems available from Applied Materials, Inc. of Santa Clara, Calif. Alternatively, at least one of the systems 402, 404 may be, e.g., a PRODUCER® integrated semiconductor substrate processing system, also available from Applied Materials, Inc.

The systems 402 and 404 are interconnected using a factory interface 424. The factory interface 424 is an atmospheric pressure interface that is used to transfer the cassettes with pre-processed and post-processed substrates 434 between various processing systems in the manufacturing region 400 of the semiconductor fab. Generally, the factory interface 424 comprises a cassette handling device 436 and a track 438. In operation, the cassette handling device 436 moves along the track 438. The cassette handling device 436 includes a cassette robot 440 and a cassette platform 442.

Each of the processing system 402, 404 includes a CENTURA® platform 405, an input/output module 432, and a system controller 450. The CENTURA® platform 405 generally comprises load-lock chambers 422, process modules 410, 412, 414, 416, 418, a vacuumed transfer chamber 428, and a substrate robot 430. The load-lock chambers 422 are used as docking stations for cassettes with substrates, as well as to protect the transfer chamber 428 from atmospheric contaminants. The substrate robot 430 transfers the substrates 434 between the load lock chambers and process modules. The input/output module 432 typically comprises a metrology module 446 and at least one front opening unified pod (FOUP) 406 (two FOUPs are shown) that facilitates an exchange of cassettes with substrates between the factory interface 424 and the processing system.

In one embodiment, the metrology module 446 includes an optical measuring system 426 (available from Applied Materials, Inc.) and substrate robots 408 and 420 which transfer pre-processed and post-processed substrates between the FOUPs 406, optical measuring system 426, and load-lock chambers 422.

The system controller 450 is coupled to and controls modules and devices of the integrated processing system. In operation, the system controller 450 enables feedback from the modules and devices to optimize substrate throughput.

In operation, the factory interface 424 transfers the processed substrates from the processing system 402 to the processing system 404. The processing system 404 comprises at least one stripping module among other process modules. Specific configuration (e.g., number of etch or stripping modules) in the systems 402 and 404 may be selected such that substrate throughput of the system 404 substantially matches the substrate throughput of the system 402.

In one embodiment, the processing system 402 includes at least one (e.g., 4 or 5) HART® etch module and the processing system 404 includes at least one AXIOM™ remote plasma module, respectively, that are used to perform portions of the present invention. The systems 402 and 404 may also comprise other process modules, such as the DPS® II module, a PRECLEAN II™ plasma cleaning module, a RADIANCE™ thermal processing module (all available from Applied Materials, Inc.), and the like.

One example of a possible configuration of the system 402 for performing processes in accordance with the present invention includes the HART® etch modules 412, 414, 416, and 418 and the PRECLEAN II™ plasma cleaning module. In the system 404, the corresponding configuration may include the AXIOM™ modules 410 and 412, the RADIANCE™ thermal processing modules 414, 416 and the DPS® II module 418.

In-situ encapsulation of the halogenic residue (e.g., residue 210) by depositing the polymeric film 212 on the substrates 200 in the etch reactors increases throughput of the system 402, as well as protects the metrology module 424 and factory interface 424 from corrosion and protects the manufacturing region 400 and substrates 200 from particle contamination. Accordingly, matching the substrate throughputs of the systems 402 and 404 increases productivity of the manufacturing region 400.

While the foregoing is directed to the illustrative embodiment of the present invention, other and further embodiments of the invention may be devised without departing from the basic scope thereof, and the scope thereof is determined by the claims that follow.

What is claimed is:

1. A method of etching, comprising:
transferring a substrate into a vacuum environment;
etching a material layer on the substrate in the vacuum environment; and
depositing a polymeric film encapsulating etch residue without removing the substrate from the vacuum environment.

2. The method of claim 1 further comprising:
transferring the substrate to an ex-situ processing reactor; and
removing the polymeric film and the residue from the substrate using the ex-situ processing reactor.

3. The method of claim 1, wherein the residue is a halogenic residue formed after etching the material layer using at least one of NF₃, CF₄, Cl₂, and HBr.

4. The method of claim 1, wherein the material layer comprises at least one of a dielectric material, a metal, and a metal alloy.

5. The method of claim 1, wherein the material layer comprises at least one of Si, polysilicon, SiO₂, HfSiO₄ and HfO₂.

6. The method of claim 1, wherein the material layer has a patterned etch mask disposed thereon.

7. The method of claim 6, wherein the patterned etch mask further comprises an anti-reflective coating (ARC).

8. The method of claim 7, wherein the ARC comprises at least one of Si₃N₄ and SiON.

9. The method of claim 6, wherein the material layer comprises trenches having an aspect ratio of about 20 to 100.

10. The method of claim 6, wherein the patterned etch mask is formed from borosilicate glass (BSG).

11. The method of claim 6, wherein the patterned etch mask is formed from photoresist.

12. The method of claim 1, wherein the encapsulating step further comprises flowing a carbon containing gas into the etch chamber that comprises at least one of a fluorocarbon gas and a hydrocarbon gas.

13. The method of claim 12, wherein the fluorocarbon gas comprises at least one of CF₄, CH₂F₂, CH₃F, CHF₃, C₂F₆, C₂F₄, C3F₈, C₄F₆, and C₄F₈.

14. The method of claim 12, wherein the hydrocarbon gas comprises at least one gas having a chemical formula CxHy, where x and y are integers.

15. The method of claim 12, wherein the carbon containing gas further comprises at least one of O₂, CO₂, H₂O, H₂, N₂, NH₃, Br₂, Cl₂, F₂, HBr, HCl, HF, NF₃, and a forming gas.

16. The method of claim 15, wherein the forming gas comprises about 3-5% of H₂ and about 97-95% of N₂.

17. The method of claim 15, wherein the encapsulating step further comprises:
providing CF₄ and H₂ at a flow ratio H₂:CF₄ in a range from about 0:1 to 5:1.

18. The method of claim 15, wherein the encapsulating step further comprises:
providing CHF₃ and H₂ at a flow ratio H₂:CHF₃ in a range from about 0:1 to 5:1.

19. The method of claim 1, wherein the transferring step further comprises a cleaning process that in-situ cleans a processing chamber of the etch reactor after the substrate is removed from the chamber.

20. The method of claim 11, wherein the removing step further strips the photoresist mask.

21. The method of claim 2, wherein the ex-situ processing reactor performs a plasma strip process.

22. The method of claim 21, wherein the plasma strip process uses at least one of O₂, water vapor (H₂O), and O₃.

23. The method of claim 22, wherein the plasma strip process further uses N₂.

24. The method of claim 2, wherein the ex-situ processing reactor performs a wet strip process.

25. The method of claim 24, wherein the wet strip process uses a solvent comprising at least one of H₂SO₄ and H₂O₂.

26. The method of claim 25, wherein the solvent comprises, by volume, about 70% of H₂SO₄ and about 30% of H₂O₂.

27. The method of claim 2, wherein the removing step further comprises a substrate cleaning process performed after the polymeric film is removed from the substrate.

28. The method of claim 27, wherein the substrate cleaning process uses a solution comprising at least one of HF, HNO₃, and HCl in deionized water

29. The method of claim 28, wherein the solution comprises, by volume, about 0.5 to 2% of HF and deionized water.

30. The method of claim 1, wherein the steps of etching depositing occur in the same reactor.

31. A method of etching, comprising:
etching a substrate in an etch reactor using a halogen containing etchant;
depositing in-situ a polymeric film encapsulating residue formed on the substrate during etching; and
removing the polymeric film and the residue from the substrate ex-situ in the reactor.

32. The method of claim 31, further comprising:
transferring the encapsulated substrate from a first integrated semiconductor substrate processing system to an ex-situ processing reactor of a second integrated semiconductor substrate processing system.

33. The method of claim 31, wherein the residue is a halogenic residue formed after etching the material layer using at least one of NF₃, CF₄, Cl₂, and HBr.

34. The method of claim 31, wherein the material layer comprises at least one of a dielectric material, a metal, and a metal alloy.

35. The method of claim 31, wherein the material layer comprises at least one of Si, polysilicon, SiO₂, and HfO₂.

36. The method of claim 31, wherein the material layer comprises structures each having a patterned etch mask.

37. The method of claim 36, wherein the patterned etch mask further comprises an anti-reflective coating (ARC).

38. The method of claim 37, wherein the ARC comprises at least one of Si₃N₄ and SiON.

39. The method of claim 36, wherein the structures are trenches having an aspect ration of about 20 to 100.

40. The method of claim 36, wherein the patterned etch mask is formed from borosilicate glass (BSG).

41. The method of claim 36, wherein the patterned etch mask is formed from photo resist.

42. The method of claim 31, wherein the depositing step uses a carbon containing gas that comprises at least one of a fluorocarbon gas and a hydrocarbon gas.

43. The method of claim 42, wherein the fluorocarbon gas comprises at least one of CF₄, CH₂F₂, CH₃F, CHF₃; C₂F₆, C₂F₄, C3F₈, C₄F₆, and C₄F₈.

44. The method of claim 42, wherein the hydrocarbon gas comprises at least one gas having a chemical formula CₓH_{y}, where x and y are integers.

45. The method of claim 42, wherein the carbon containing gas further comprises at least one of O₂, CO₂, H₂O, H₂, N₂, NH₃, Br₂, Cl₂, F₂, HBr, HCl, HF, NF₃, and a forming gas.

46. The method of claim 45, wherein the forming gas comprises about 3-5% of H₂ and about 97-95% of N₂.

47. The method of claim 45, wherein the depositing step further comprises:
providing CF₄ and H₂ at a flow ratio H₂:CF₄ in a range from about 0:1 go 5:1.

48. The method of claim 45, wherein the depositing step further comprises:
providing CHF₃ and H₂ at a flow ratio about H₂:CHF₃ in a range from 0:1 to 5:1.

49. The method of claim 41, wherein the removing step further strips the photoresist mask.

50. The method of claim 31, wherein the ex-situ processing reactor performs a plasma strip process.

51. The method of claim 50, wherein the plasma strip process uses at least one of O₂, water vapor (H₂O), and O₃.

52. The method of claim 51, wherein the plasma strip process further uses N₂.

53. The method of claim 31, wherein the ex-situ processing reactor performs a wet strip process.

54. The method of claim 51, wherein the wet strip process uses a solvent comprising at least one of H₂SO₄ and H₂O₂.

55. The method of claim 31, wherein the removing step further comprises a substrate cleaning process performed after the polymeric film is removed from the substrate.

56. The method of claim 55, wherein the substrate cleaning process uses a solution comprising at least one of HF, HNO₃, and HCl in deionized water
